(19) United States
(12) Patent Application Publication
(10) Pub. No.: US 2013/0179347 A1
(43) Pub. Date: Jul. 11, 2013

(54) MOBILE APPLICATION FACILITATING MONETARY OR OTHER DONATIONS

(71) Applicant: Robert W. Soderstrom, Los Angeles, CA (US)

(72) Inventor: Robert W. Soderstrom, Los Angeles, CA (US)

(21) Appl. No.: 13/738,949

(22) Filed: Jan. 10, 2013

Related U.S. Application Data
(60) Provisional application No. 61/585,075, filed on Jan. 10, 2012.
(60) Provisional application No. 61/610,912, filed on Mar. 14, 2012.

(51) Int. Cl. G06Q 40/00

(52) U.S. Cl. CPC G06Q 40/00
USPC 705/44; 705/329; 705/319

(57) ABSTRACT

The present invention relates to an application on a mobile phone or other portable digital device that allows a user to utilize a digital wallet to round up a purchase to the nearest dollar and then contribute that change to a third party, like a non-profit organization or fundraising campaign. In some embodiments, the present invention may be incorporated directly within a digital wallet on a mobile device. In other embodiments the present invention may be a stand-alone application on a mobile device that interfaces with a digital wallet.

### CROSS REFERENCE TO RELATED APPLICATIONS

This application claims the benefit of U.S. Provisional Patent Application Ser. No. 61/585,075, titled MOBILE APPLICATION FACILITATING MONETARY OR OTHER DONATIONS, filed Jan. 10, 2012, and of U.S. Provisional Patent Application Ser. No. 61/610,912, titled MOBILE APPLICATION FACILITATING MONETARY OR OTHER DONATIONS, filed Mar. 14, 2012.

### SUMMARY OF THE INVENTION

The present invention relates to an application on a mobile phone, portable digital device or personal computer that allows a user to utilize a digital wallet to round up a purchase to the nearest dollar and then contribute that change to a third party, like a non-profit organization.

For example, if a user uses their digital wallet to make a purchase of $7.72, the present invention would allow the user to round-up 28 cents to the nearest dollar ($8.00). The 28 cents is then held, and the user can decide to distribute it to a third party at the time of the transaction or at a later date.

Reference is made throughout the present disclosure to certain aspects of one embodiment of the application described herein. Such references to aspects of the presently described application do not limit the scope of the claimed invention. Additionally, any examples set forth in this disclosure are not intended to be limiting and merely set forth some of the many possible embodiments for the appended claims. It is to be understood that the phraseology and terminology used herein are for the purpose of description and should not be regarded as limiting.

### BRIEF DESCRIPTION OF THE DRAWINGS

FIG. 1 is an example graphical user interface according to one embodiment of the mobile application.

FIG. 2 is an example graphical user interface according to one embodiment of the mobile application.

FIG. 3 is a schematic block diagram of an example computing system.

### DETAILED DESCRIPTION

Various user interfaces and embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims. It is understood that various omissions and substitutions of equivalents are contemplated as circumstances may suggest or render expedient, but these are intended to cover applications or embodiments without departing from the spirit or scope of the claims attached hereto. Also, it is to be understood that the phraseology and terminology used herein are for the purpose of description and should not be regarded as limiting.

### Mechanics and Larger Ecosystem

In some embodiments, the present invention may be incorporated directly within a digital wallet on a mobile device. In other embodiments the present invention may be a stand-alone application on a mobile device that interfaces with a digital wallet. The system also facilitates aggregation of personal donations between individuals, organizations, fundraising campaigns and physical locations. The system further permits various means of communication, including social media communication and notification, related to donation and aggregation activity.

In a preferred embodiment of the present invention, the user, in a retail store environment or an online purchase environment, is charged for only the rounded up amount (28 cents, in the example above) as if it were a purchase. The round-up could occur automatically on the device or be approved by the user at the time of the transaction. The user's rounded up amounts are tallied over time until the user decides to distribute them to a third party, for example, a non-profit organization or fundraising campaign.

With an on-screen menu, the user may choose to augment the rounded-up amount with the push of a button, increasing the rounded-up amount from $0.28 to $5.28 or $100.28, for example.

The funds may be credited to a central receiving party. The receiving party in turn allows the user to donate the accumulated amount to a third party, like a non-profit organization or fundraising campaign. The central receiving party then distributes those funds to the third party or parties elected by the user, for example, non-profit organizations or fundraising campaigns.

In one example, the user may round-up a purchase amount on March 1^{st}, but not donate the funds until September 1^{st}. In this example, the funds may generate interest over the time they are held by the central receiving party. The central receiving party may be entitled to keep the interest generated from the funds it holds during that time, or the interest may be added to the donated amount.

In another example, the elected rounded up amount may be included in the user's purchase at a retail shop. In this example, the retailer would be responsible for the disbursement of funds to a third party.

In another example, the rounded up amount may go toward the purchase of virtual goods. In other words, the central receiving party sells virtual goods to the user. In the previous example of the 28 cent rounded up amount, the user actually purchases 28 widgets. The user can later send the widgets to a third party, like a non-profit organization or fundraising campaign, at which point the central receiving party converts the widgets back to currency and gives real currency to the third party.

The present invention involves technology that is capable of communicating with multiple parties, including but not limited to, a mobile phone or smart phone, retailer, mobile wallet, and website, and possibly financial institutions.

### Potential Roles of a Retailer

There are various ways a retailer can enhance a user's rounded up amount on a purchase, for example, by matching the rounded up amount with an in-store discount. If a user rounds up by 28 cents, the retailer may make that donation on behalf of the user. Alternatively, the retailer may add the same amount to the rounded up amount [making it 28 cents (user)+28 cents (retailer)=56 cents total] to enhance the user's rounded up amount. In that regard, the retailer matches the user's rounded up amount and also reinforces the user's allegiance to the retailer because the retailer is honoring whatever third party, like a non-profit organization or fundraising campaign, is important to the user.

The retailer may also double, triple, and so on, the user's rounded up amount.

Further, a retailer may deposit an amount, for example, $20, into a user's rounded up amount account as a promotion. The user is then free to advance those monies to a non-profit organization or fundraising campaign. However, the user only “earns” the $20 if they shop at the retailer's store in a set amount of time (for example, they must buy $200 at the retailer's store within 30 days for the $20 to be credited in real money to the user's third party of choice).

The disclosed application can allow for numerous variations of ways to calculate the relationship between specific variables, including (among other options) the rounded up amount, a potential discount, matching funds, future discounts, and contributions to particular non-profit organizations or fundraising campaigns.

In some embodiments, a retailer may have a non-profit organization or fundraising campaign that it supports (for example, the Red Cross), and a user can elect to donate their rounded up amount to the retailer's campaign, and/or split the rounded up amount between the retailer's campaign and the user's campaign.

### Extras

An ecosystem can be created that connects the funds from rounded up amounts to third party fundraising campaigns on websites like Kickstarter, GlobalGiving and Kiva, among others. Thus, a central website may offer all campaigns in a single destination and allow users to go there to distribute their accumulated rounded up funds.

Also, retailers may begin to show a physical symbol or sticker that announces the ability for a user to utilize the present invention at that retailer's place of business and therefore partner with that retailer (in a way) to do good in the world.

In another embodiment, the user could designate specific merchants in advance and receive location-specific messages (via GPS, Wi-Fi, or other location technologies), offers or benefits when in proximity to a retailer participating in the program. The user could also designate certain non-profits or charitable institutions whose location may trigger similar notices or messages. Thus, the user on foot could be alerted to the existence of a retailer or non-profit and engage in a purchase, yielding additional savings, or make a donation.

A user may assign a name or number to their own fundraising cause. That number is associated with that user's efforts to raise money. The user can utilize that number to recruit friends to a particular fundraising campaign. This could also cause location-specific notices to be sent to friends when they are in physical proximity to a participating retailer or designated non-profit.

The rounded up amount may be incorporated into an online retail store and catalogue in some embodiments, where users can round up their purchases, but also share with others their own “store” on social networking sites that promote products they like.

### Integration with Social Media/Social Networking Sites

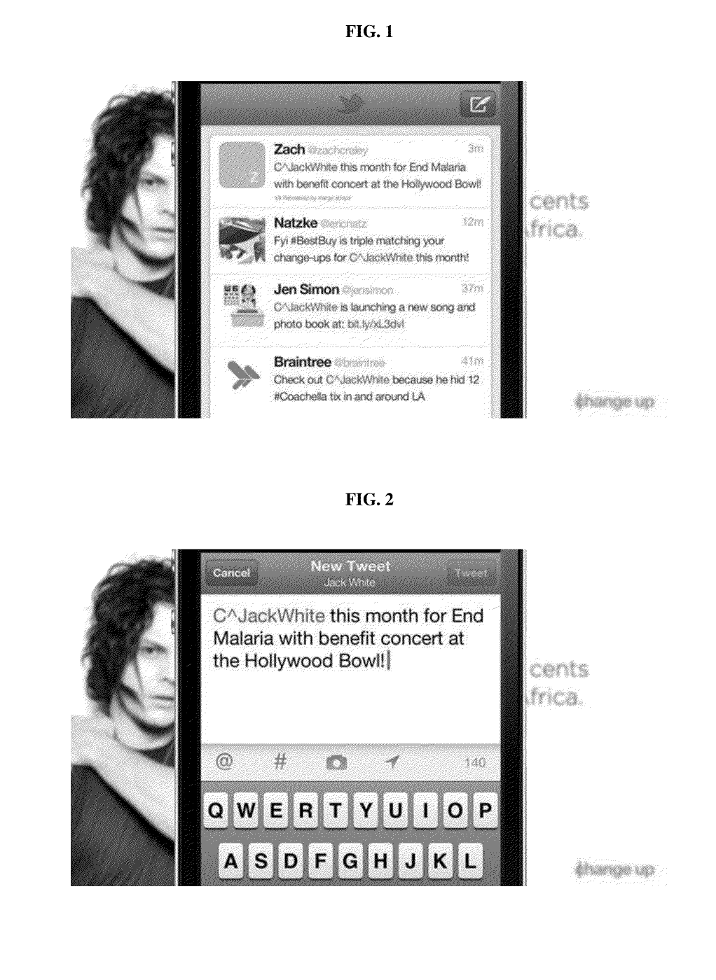

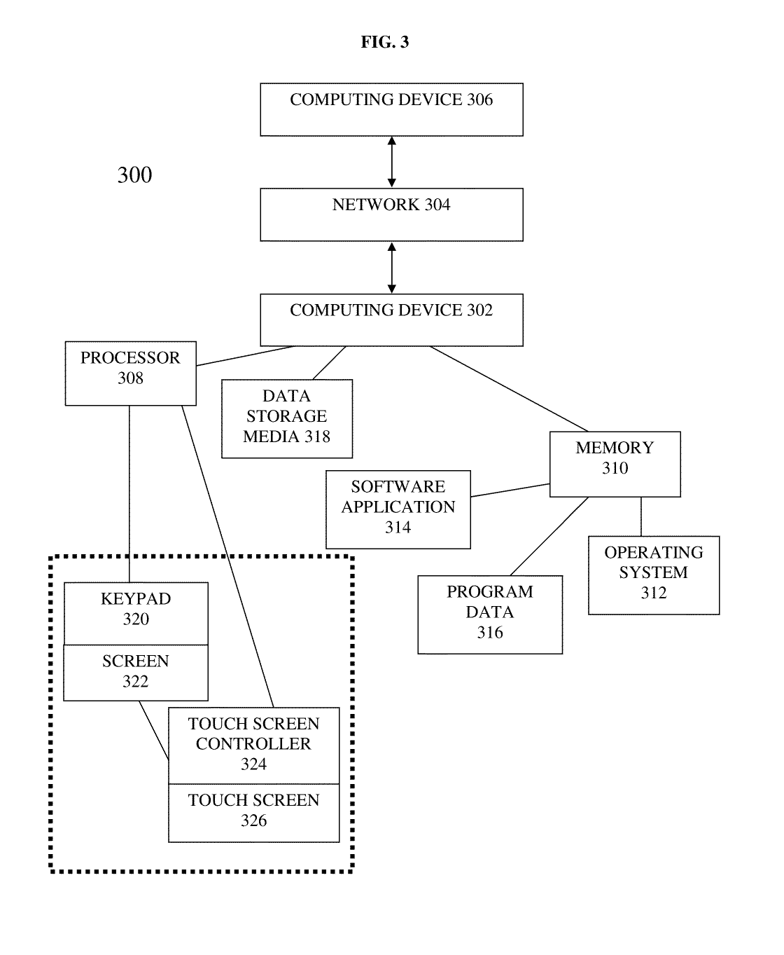

In some embodiments, the present invention can be integrated with social media and social networking sites. For example, a user may want to lead a fundraising effort on a social network, such as Twitter or Facebook. The user might post an update to their social networking profile that includes a previously designated combination of characters (for example, “CA”) that, when included before a series of words, create a hyperlink to a specific non-profit organization or fundraising campaign. Examples of integration of the present invention with social media are shown in FIG. 1 and FIG. 2.

The integration of the present invention with social networking sites allows users to lead, promote and contribute to fundraising campaigns using a previously designated character or combination of characters that is/are inter-operable with a mobile application or any other application that relates to the present invention, like a digital wallet application, and allows users to automatically apply their rounded up amounts to a non-profit organization or fundraising campaign of their choosing. The rounded up amounts may be applied on a one-time basis in some examples, or may be applied for a specified period of time (i.e., one month).

As an example of the integration with social media, a user might want to use the social networking site Twitter as a means to promote or contribute to a fundraising campaign led by a celebrity, like Jack White. In this example, the user would “tweet” the following: “#ĈJackWhite” followed by any phrase that they think might entice others to promote or contribute to the designated non-profit organization or fundraising campaign. For example, a user might tweet the following: “#ĈJackWhite this month for End Malaria with benefit concert at Hollywood Bowl!” (See FIG. 2) In that tweet, the portion “#ĈJackWhite” becomes a hyperlink when posted to Twitter, allowing other users to click on the hyperlink and automatically enroll in the fundraising campaign and apply their rounded up amounts toward the campaign. In some examples, clicking this hyperlink may automatically enroll the user for a certain amount of time, i.e., one month. Other users may also have the ability to “re-tweet” the aforementioned phrase in order to further promote the designated non-profit organization or fundraising campaign. The notation “Ĉ” used in this example may be any notation that is previously designated by the social networking site for this purpose, and is used here only as an example of what the notation may be.

In some embodiments, the disclosed application may send a notification to the donor or to the recipient of funds (for example, a non-profit organization or fundraising campaign) when funds are donated using the system. These notifications may be sent to a user or fund recipient through a social network, such as Twitter or Facebook, or may be sent by other delivery routes such as email or text message.

Updates to a user's social networking profile related to the present invention can be done in any way that is allowed by the social networking site, for example by use of a personal computer, smart phone or other mobile device. The illustrations in FIG. 1 and FIG. 2 show an example of a combination of characters that create a hyperlink within a user's Twitter update, which has been integrated into a social media mobile application.

### Mutual Funds of a Sort

Millions of people may round up amounts on purchases daily, therefore contributing large amounts of monies into a central holding fund, which may operate as a bank of sorts, or a mutual fund that grows, earns interest, and delivers dividends.

### System Technical Components

In general terms, the present disclosure relates to an online or mobile application that is executed using a computing system. FIG. 3 is a schematic block diagram of an example computing system 300. The disclosed application involves technology that communicates with a mobile phone, retailer, mobile wallet, and website, and possibly financial institutions, and more, and uses a computing system 300. The example computing system 300 includes at least one computing device 302. In some embodiments the computing system 300 further includes a communication network 304 (such as the internet or a cellular network) and one or more additional computing devices 306 (such as a server).

The computing device 302 can be, for example, a smart phone or other mobile device, a tablet computing device, a netbook, a computing device located in a retail store or other place of business, a computing device located in a user's home, or any other computing device. Computing device 302 can be a stand-alone computing device or a networked computing device that communicates with one or more other computing devices 306 across a network 304. The additional computing device(s) can be, for example, located remotely from the first computing device, but configured for data communication with the first computing device across a network 304.

In some examples, the computing device 302 and 306 includes at least one processor or processing unit 308 and system memory 310. Depending on the exact configuration and type of computing device, the system memory 310 may be volatile (such as RAM), non-volatile (such as ROM, flash memory, etc.) or some combination of the two. System memory 310 typically includes an operating system 312 suitable for controlling the operation of the computing device, such as the WINDOWS® operating systems from Microsoft Corporation of Redmond, Wash. or a server, such as Windows SharePoint Server, also from Microsoft Corporation. To provide further example, if the computing device 302 is a smart phone or other mobile device, the operating system 312 may be iOS, WP7, Android, or any other available mobile operating system. The system memory 310 may also include one or more software applications 314 and may include program data 316. The software applications 314 may be in the form of mobile applications in examples wherein the computing device 302 is a mobile device.

The computing device 302 may have additional features or functionality. For example, the device may also include additional data storage devices 318 (removable and/or non-removable) such as, for example, magnetic disks, optical disks, or tape. Computer storage media 318 may include volatile and nonvolatile, removable and non-removable media implemented in any method or technology for storage of information, such as computer readable instructions, data structures, program modules, or other data. System memory, removable storage, and non-removable storage are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device. An example of computer storage media 318 is non-transitory media. The computing device 306 may include data storage media such as the data storage media 318 described above, on which application data is stored.

In some examples, one or more of the computing devices 302, 306 can be located in an establishment, such as a retail store or other place of business. In other examples, one or more of the computing devices 302, 306 can be a smart phone or other mobile device. FIG. 3 includes a schematic diagram of such device. The computing device 302 may be a smart phone or other mobile device with input device options including, but not limited to, a keypad 320, a screen 322, a touch screen controller 324, and/or a touch screen 326. In other examples, the computing device can be a personal computing device that is networked to allow the user to access the application disclosed herein at a remote location, such as in a user's home or other location. In some embodiments, components of the application are stored as data instructions for a smart phone application. A network 304 facilitates communication between the computing device 302 and one or more servers, such as an additional computing device 306, that host the application. The network 304 may be a wide variety of different types of electronic communication networks. For example, the network may be a wide-area network, such as the Internet, a local-area network, a metropolitan-area network, a cellular network or another type of electronic communication network. The network 304 may include wired and/or wireless data links. A variety of communications protocols may be used in the network including, but not limited to, Ethernet, Transport Control Protocol (TCP), Internet Protocol (IP), Hypertext Transfer Protocol (HTTP), SOAP, remote procedure call protocols, and/or other types of communications protocols.

In some examples, the additional computing device 506 is a Web server. In this example, the first computing device 302 includes a Web browser that communicates with the Web server to request and retrieve data. The data is then displayed to the user, such as by using a Web browser software application. In some embodiments, the various operations, methods, and rules disclosed herein are implemented by instructions stored in memory. When the instructions are executed by the processor of one or more of the computing devices 302 and/or 306, the instructions cause the processor to perform one or more of the operations or methods disclosed herein. Examples of operations include the rounding up of a purchase to the nearest dollar, the storage of the funds originating from the rounded up amount and/or the delivery of location-specific messages, offers or benefits.

As noted, the application could work in combination with existing digital wallet applications or be its own digital wallet application with the round-up functionality and social network engagement embedded therein.

The various embodiments described above are provided by way of illustration only and should not be construed to limit the claims attached hereto. Those skilled in the art will readily recognize various modifications and changes that may be made without following the example embodiments and applications illustrated and described herein and without departing from the true spirit and scope of the following claims.

What is claimed is:

1. A method of payment to a charitable organization in a computing system comprising at least one server to host the payment system and at least one computing device communicably coupled to the at least one server through a communication network, the method comprising:
an individual making payment to a third party seller through a computing device;
presenting an optional additional payment option to a charitable organization connected with the first payment;
selecting a receiving charitable organization for the additional payment;
selecting an amount for the additional payment; and
authorizing payment of both the first payment and the additional payment through at least one server.

2. The method of claim 1, wherein at least one computing device is one of a mobile device and a computer communicably coupled with the at least one server for data communication.

3. The method of claim 2, wherein at least one computing device is located at a retail establishment and a remote location.

4. The method of claim 1 wherein the receiving organizations are determined prior to first payment.

5. The method of claim 1 where the amount for the additional payment is a pre-determined percentage of payment amounts to third party sellers.

6. The method of claim 1 wherein the receiving party receives electronic notification of a payment authorization.

7. A system for online payment to charitable organizations comprising:
a computer network for management and transmission of an individual's online payment data and designation of charitable organizations to receive payment;
a data storage device for storing individual online payment data, designation of charitable organizations to receive payment and the geographic locations of the charitable organizations;
a server configured to receive data about the real world, including geographic location of an individual;
a mobile computing device configured to transmit data including geographic location of an individual; and
a server configured to transmit information on at least one charitable organizations associated with an individual's geographic location.

8. The system of claim 7, wherein the interface is configured to make a payment to the at least one charitable organization associated with an individual's geographic location.

9. The system of claim 7, wherein the interface is configured to allow the individual to transmit information on the payment to the at least one charitable organization to a social media feed.
